(19) United States
(12) Patent Application Publication
(10) Pub. No.: US 2023/0330555 A1
(43) Pub. Date: Oct. 19, 2023

(54) BLOCK-TYPE ART KIT

(71) Applicants: Hyochan JUN, Jeju-si (KR); Jonghyun JUN, Auckland (NZ)

(72) Inventors: Hyochan JUN, Jeju-si (KR); Jonghyun JUN, Auckland (NZ)

(21) Appl. No.: 18/297,363

(22) Filed: Apr. 7, 2023

(30) Foreign Application Priority Data
Apr. 15, 2022 (KR) 10-2022-0046640
Jan. 11, 2023 (KR) 10-2023-0003791

(51) Int. Cl. A63H 33/08

(52) U.S. Cl. CPC A63H 33/086

(57) ABSTRACT

A block-type art kit is proposed. The kit may include a block frame including a plurality of coupling protrusions arranged at regular intervals in row and column directions on an upper surface thereof. The block-type art kit may further include a plurality of color blocks each having a coupling recess provided from a lower surface thereof such that the coupling protrusion is inserted into the coupling recess. The coupling protrusion may have a through hole formed at a center thereof in a direction penetrating the block frame. The block-type art kit can make it possible to have more diverse expressions in pixel art and makes it easy to modify the created image.

### CROSS REFERENCE TO RELATED APPLICATIONS

The present application claims priority to Korean Patent Application No. 10-2022-0046640 filed Apr. 15, 2022, and Korean Patent Application No. 10-2023-0003791 filed Jan. 11, 2023, the entire contents of each of which are incorporated herein for all purposes by this reference.

### BACKGROUND

### Technical Field

The present disclosure relates to a block-type art kit that is easy to assemble and disassemble and capable of various expressions.

### Description of Related Technology

Pixel art is one of the arts for children's play, development, or hobbies. The pixel art is a technique to express a desired image by preparing mediums serving as pixels in various colors and arranging the mediums of various colors at desired positions. The mediums serving as pixels include, for example, threads, blocks, beads, and the like.

### SUMMARY

One aspect is a block-type pixel art kit capable of more diverse expressions and easy modification of image.

Another aspect is a block-type art kit that may include a block frame including a plurality of coupling protrusions arranged at regular intervals in row and column directions on an upper surface thereof, and a plurality of color blocks each having a coupling recess provided from a lower surface thereof such that the coupling protrusion is inserted into the coupling recess. The coupling protrusion may have a through hole formed at a center thereof in a direction penetrating the block frame.

In addition, the coupling protrusion may have a rectangular shape on a horizontal cross-section and have an auxiliary coupling groove on each of four side surfaces.

The block-type art kit may further include a plurality of quarter color blocks each formed to have a horizontal cross-section of a quarter of the size of the color block, each quarter color block having a second coupling recess at one lower corner portion thereof such that one corner portion of the coupling protrusion is inserted into the second coupling recess.

In addition, a block detachable hole may be formed at a bottom of a side of the color block.

The block-type art kit may further include an adapter block for connecting the coupling protrusion and the color block.

In addition, the adapter block may have a horizontal cross-section of the same shape as that of the coupling protrusion and have a fixing protrusion formed on a lower surface thereof to be inserted into the through hole of the coupling protrusion.

The block-type art kit may further include an auxiliary adapter block having a smaller height than the coupling protrusion, and having at a center thereof a coupling hole having a shape engaged with the coupling protrusion.

The block-type art kit may further include a second adapter block for connecting the coupling protrusion and the adapter block.

In addition, the second adapter block may be formed to surround the coupling protrusion at a lower portion thereof and have at an upper portion thereof the same horizontal cross-section as that of the coupling protrusion. Also, the second adapter block may have at a center thereof a second through hole vertically penetrating the second adapter block.

The block-type art kit may further include a plurality of frame coupling protrusions formed on a lower surface of the block frame and arranged to be spaced apart in the row and column directions.

The block-type art kit may further include a bent connection member composed of a first plate portion and a second plate portion connected to each other at a right angle, each of the first plate portion and the second plate portion having a frame coupling hole into which the frame coupling protrusion is inserted.

The block-type art kit may further include a flat connection member having a plate shape and having a plurality of second frame coupling holes into which the frame coupling protrusions are inserted.

The block-type art kit may further include a corner member having one third frame coupling hole into which the frame coupling protrusion is inserted.

According to the block-type art kit of the present disclosure, it is easy to remove the color block coupled to the block frame, so that an image created by the block-type art kit can be easily changed.

Also, in addition to the color block, the quarter color block having a size of a quarter of the color block can be combined with the block frame, so that an image created by the block-type art kit can be expressed in more detail.

In addition, it is possible to express an image created by the block-type art kit in a three dimension using the adapter block and the second adapter block, so that the image can be expressed in more diverse ways.

### BRIEF DESCRIPTION OF THE DRAWINGS

FIG. 1 is a perspective view illustrating a block-type art kit according to the present disclosure.

FIG. 2 is a cross-sectional view illustrating a block-type art kit according to the present disclosure.

FIG. 3A shows various views illustrating a quarter color block used in a block-type art kit according to the present disclosure.

FIG. 3B shows various views illustrating a half color block used in a block-type art kit according to the present disclosure.

FIG. 4 shows various views illustrating an adapter block used in a block-type art kit according to the present disclosure.

FIG. 5 shows various views illustrating an auxiliary adapter block used in a block-type art kit according to the present disclosure.

FIG. 6 shows various views illustrating a second adapter block used in a block-type art kit according to the present disclosure.

FIG. 7 is a perspective view illustrating a lower surface of a block frame used in a block-type art kit according to the present disclosure.

FIGS. 8A to 8C show various views illustrating a bent connection member used in a block-type art kit according to the present disclosure.

FIG. 9 shows various views illustrating a flat connection member used in a block-type art kit according to the present disclosure.

FIGS. 10 and 11 show various views illustrating another flat connection member used in a block-type art kit according to the present disclosure.

FIG. 12 shows various views illustrating a corner member used in a block-type art kit according to the present disclosure.

FIGS. 13A and 13B show various views illustrating an auxiliary connection member used in a block-type art kit according to the present disclosure.

FIG. 14 is a view illustrating an exemplary connection of block frames using flat connection members and so on used in a block-type art kit according to the present disclosure.

### DETAILED DESCRIPTION

The pixel art has the advantage of being accessible and enjoyable to anyone because it can easily express a variety of images by arranging the mediums that act as pixels.

However, since the pixel mediums have a uniform shape, there are bound to be restrictions on expression. In addition, when the size of the pixel medium (particularly, a block) is reduced to enable more detailed expression, there is a problem in that it is not easy to change the position of the pixel medium once it is fixed.

Hereinafter, various embodiments of the present disclosure will be described in detail with reference to the accompanying drawings. The present disclosure may, however, be embodied in many different forms and should not be construed as being limited to the embodiments set forth herein. Rather, these embodiments are provided so that the invention will be thorough and complete and will fully convey the scope of the invention to those skilled in the art.

In the following description of embodiments, techniques that are well known in the art and not directly related to the present disclosure are not described. This is to clearly convey the subject matter of the present disclosure by omitting an unnecessary explanation. For the same reason, some elements in the drawings are exaggerated, omitted, or schematically illustrated. Also, the size of each element does not entirely reflect the actual size. In the disclosure, the same or corresponding elements are denoted by the same reference numerals.

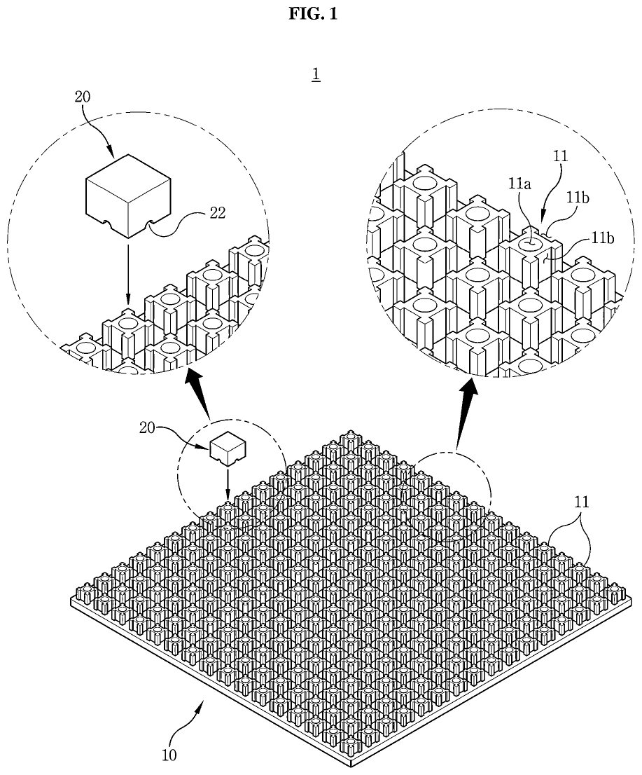

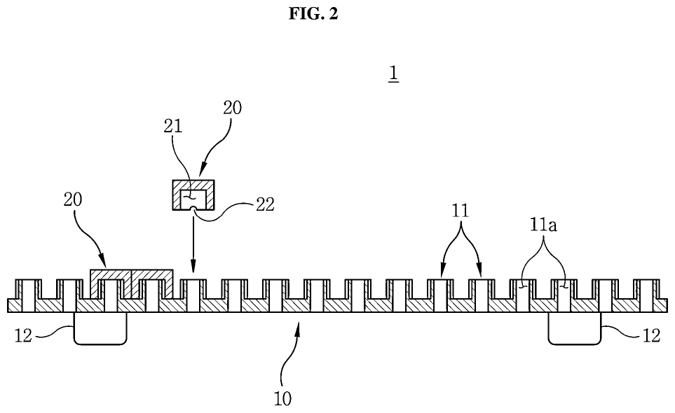

FIG. 1 is a perspective view illustrating a block-type art kit 1 according to the present disclosure, and FIG. 2 is a cross-sectional view illustrating a block-type art kit 1 according to the present disclosure.

The block-type art kit 1 according to the present disclosure basically includes a block frame 10 and a plurality of color blocks 20.

The color blocks 20 used in the block-type art kit 1 have various colors. Arranging the color blocks 20 of different colors at desired positions on the block frame 10, respectively, it is possible to create a desired image.

The block frame 10 has a plate shape as a whole. Although FIG. 1 shows the block frame 10 formed of a rectangular plate shape, it is also possible to form a circular, hexagonal, or any other shape. A plurality of coupling protrusions 11 are provided on the upper surface of the block frame 10. The coupling protrusions 11 are arranged at regular intervals in the row and column directions, and may be formed on the entire surface of the block frame 10. The coupling protrusion 11 serves to fix the color block 20 to the block frame 10.

The color block 20 has a hexahedral shape as a whole. A horizontal cross-sectional size of the collar block 20 corresponds to the size of a space occupied by one coupling protrusion 11 on the block frame 10. A coupling recess 21 is provided from the lower surface of the color block 20 so that the coupling protrusion 11 of the block frame 10 can be inserted. The color block 20 can be fixed to the block frame 10 when the coupling recess 21 of the color block 20 is fitted with the coupling protrusion 11 of the block frame 10.

Each coupling protrusion 11 has a through hole 11a formed at the center thereof in a direction penetrating the block frame 10, that is, in a vertical direction.

If the distance between the adjacent coupling protrusions 11 or the size of each color block 20 is reduced in order to make an image created by the block-type art kit 1 more detailed, it may be difficult to change the position of the color block 20 after fitted with the coupling protrusion 11 of the block frame 10. In particular, it is not easy to remove the color block 20 surrounded by neighboring color blocks 20 from the block frame 10.

The through hole 11a makes it possible to easily remove the color block 20 fixed to the block frame 10 so that the position of the color block 20 can be easily changed. That is, the color block 20 can be easily removed from the block frame 10 when a pointed object such as an awl or a pin is inserted into the through hole 11a from the bottom of the block frame 10 to push the color block 20 out.

The color block 20 may have various sizes. That is, one color block 20 may be formed to have various numbers of coupling recesses 21. In this case, such respective coupling recesses 21 of one color block 20 are formed at the same interval as the coupling protrusions 11 of the block frame 10 to be fitted with the block frame 10.

The coupling protrusion 11 may have a rectangular shape on a horizontal cross-section and may have an auxiliary coupling groove 11b on each of four side surfaces. The auxiliary coupling groove 11b is formed in a long rectangular shape on the horizontal cross-section of the coupling protrusion 11 and is extended over the entire height direction (vertical direction) of the coupling protrusion 11.

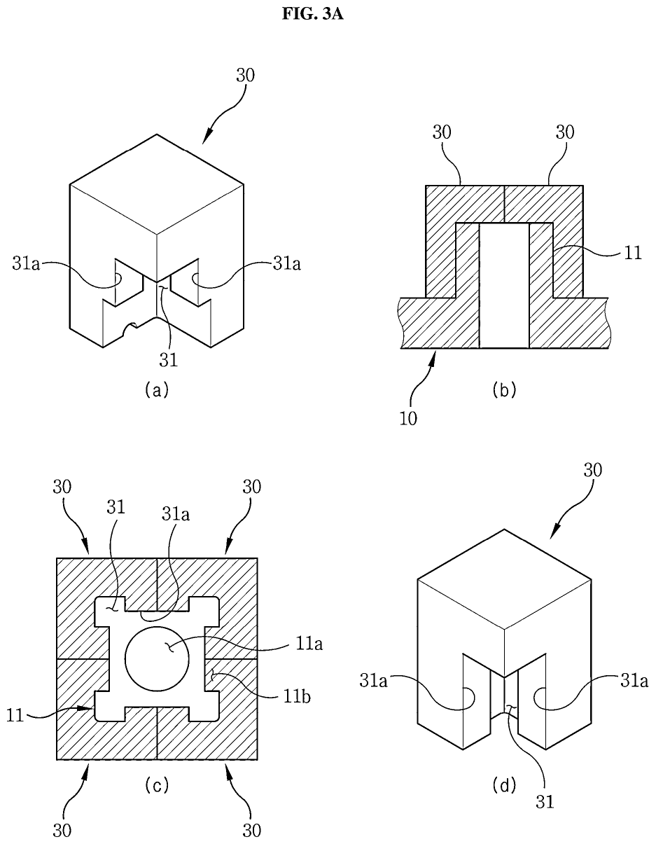

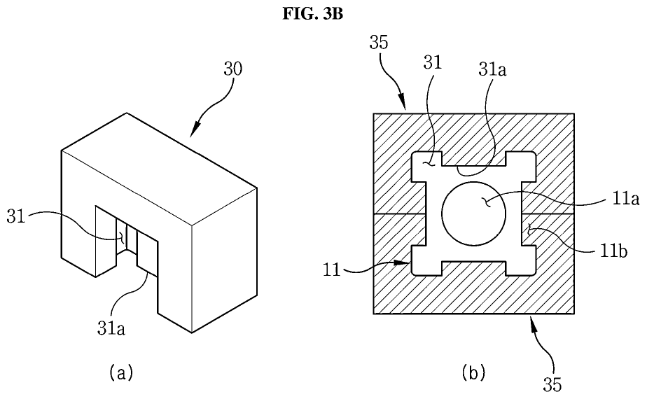

In the case that the coupling protrusion 11 has the auxiliary coupling groove 11b, the block-type art kit 1 according to the present disclosure may further include a plurality of quarter color blocks 30. FIG. 3A shows perspective views and cross-sectional views illustrating a quarter color block 30 used in a block-type art kit according to the present disclosure (see (a), (b), (c), and (d) of FIG. 3A).

The quarter color block 30 is formed of a hexahedral shape having a horizontal cross-section of a quarter of the size of the color block 20. In addition, the height of the quarter color block 30 is the same as the height of the color block 20. Thus, when four quarter color blocks 30 are arranged, they occupy substantially the same area as the area occupied by one color block 20.

The quarter color block 30 has a second coupling recess 31 at one lower corner portion thereof. One corner portion of the coupling protrusion 11 can be inserted into the second coupling recess 31. That is, four quarter color blocks 30 can be fitted with four corner portions of the coupling protrusion 11 to fill the space occupied by one color block 20.

The quarter color block 30 makes it possible to more precisely express an image created using the block-type art kit 1 of the present disclosure.

The second coupling recess 31 has a rectangular shape on a horizontal cross-section. In addition, the second coupling recess 31 has an auxiliary coupling protrusion 31a formed on the inner surface thereof to face and be engaged with the auxiliary coupling groove 11b of the coupling protrusion 11. The quarter color block 30 having the second coupling recess 31 is coupled to the coupling protrusion 11 as if gripping the corner portion of the coupling protrusion 11, it can be firmly fixed to the coupling protrusion 11. The auxiliary coupling protrusion 31a may be formed only at an upper portion of the second coupling recess 31 in the height direction as shown in (a) of FIG. 3A, or may be extended over the entire height direction of the second coupling recess 31 as shown in (d) of FIG. 3A.

As shown in (a) and (b) of FIG. 3B, the block-type art kit 1 according to the present disclosure may further include a half color block 35 formed to be half the size of the color block 20. Like the quarter color block 30 discussed above, the half color block 35 may have the second coupling recess 31 and the auxiliary coupling protrusion 31a.

Meanwhile, a block detachable hole 22 may be formed at the bottom of the side of the color block 20.

By inserting a pointed object such as an awl or a pin into the block detachable hole 22 and lifting the color block 20, the color block 20 fixed to the block frame 10 can be easily removed from the block frame 10.

The block detachable hole 22 may be formed on only some or all of the four sides of the collar block 20.

In addition, the block detachable hole 22 can be formed at the bottom of the side of the quarter color block 30 or the half color block 35.

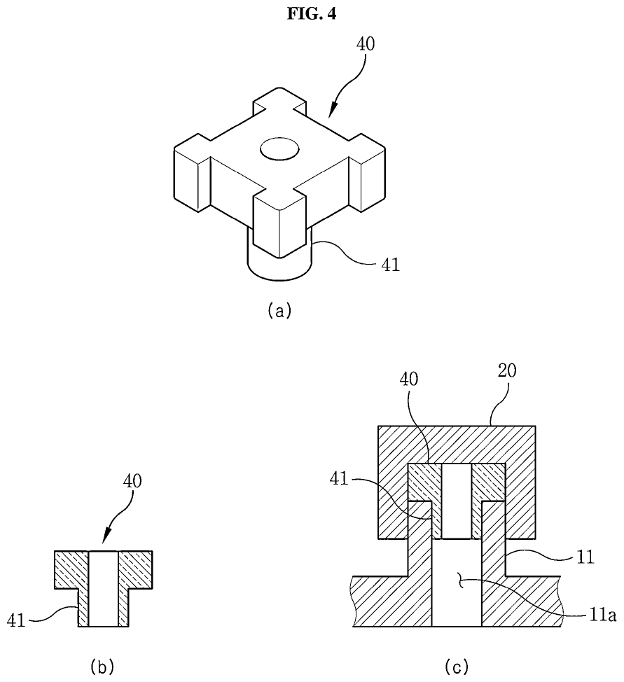

The block-type art kit 1 according to the present disclosure may further include an adapter block 40. FIG. 4 shows various views illustrating an adapter block 40 used in a block-type art kit according to the present disclosure (see (a), (b), and (c) of FIG. 4).

The adapter block 40 serves to connect the coupling protrusion 11 of the block frame 10 and the color block 20. That is, after the adapter block 40 is fitted with the coupling protrusion 11 of the block frame 10, the color block 20 can be fitted with the adapter block 40.

In the case of coupling the color block 20 to the block frame 10 by using the adapter block 40, the color block 20 will further protrude from the block frame 10 compared to the case of directly coupling the color block 20 to the block frame 10. It is therefore possible to form an image three-dimensionally and diversify image expression through the block-type art kit 1 of the present disclosure.

Specifically, the adapter block 40 has a horizontal cross-section of the same shape as that of the coupling protrusion 11 and has a fixing protrusion 41 formed on a lower surface thereof. The fixing protrusion 41 can be inserted into the through hole 11a of the coupling protrusion 11 to be engaged with the coupling protrusion 11. The adapter block 40 can be fixed to the block frame 10 when the fixing protrusion 41 is inserted into the through hole 11a of the coupling protrusion 11, and the color block 20 can be fixed to the adapter block 40 when the coupling recess 21 of the color block 20 is fitted with the adapter block 40.

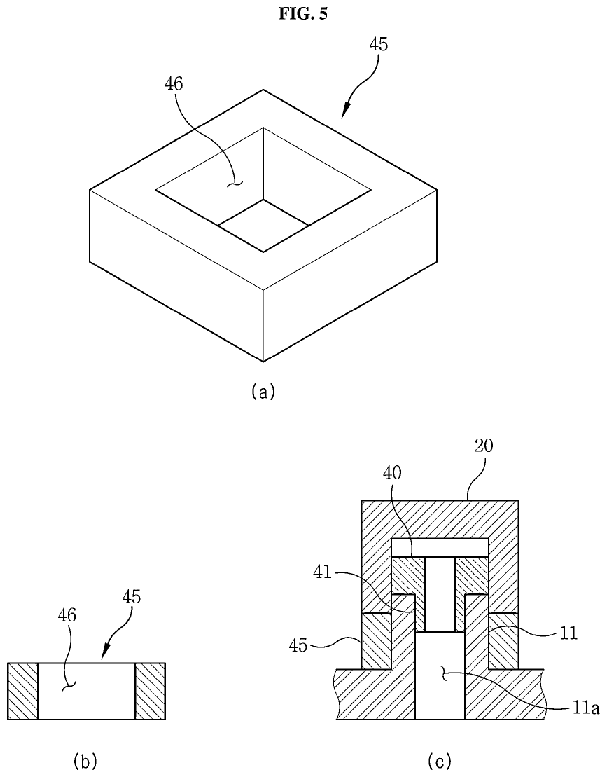

The block-type art kit 1 according to the present disclosure may further include an auxiliary adapter block 45. FIG. 5 shows various views illustrating an auxiliary adapter block 45 used in a block-type art kit according to the present disclosure (see (a), (b), and (c) of FIG. 5).

The auxiliary adapter block 45 is formed in a thin square tube shape having a smaller height than the coupling protrusion 11 of the block frame 10. The auxiliary adapter block 45 has at the center thereof a coupling hole 46 having a shape engaged with the coupling protrusion 11. The coupling hole 46 is formed to vertically penetrate the auxiliary adapter block 45.

The auxiliary adapter block 45 serves to adjust the height of the color block 20 in the case where the adapter block 40 is used. That is, as shown in (c) of FIG. 5, after coupling the adapter block 40 and the auxiliary adapter block 45 to the coupling protrusion 11, the color block 20 can be coupled to the adapter block 40. If this is done, the length at which the color block 20 is coupled to the adapter block 40 is reduced due to the height of the auxiliary adapter block 45. Therefore, compared to the case where there is no auxiliary adapter block 45, the color block 20 can be coupled to a higher position from the block frame 10.

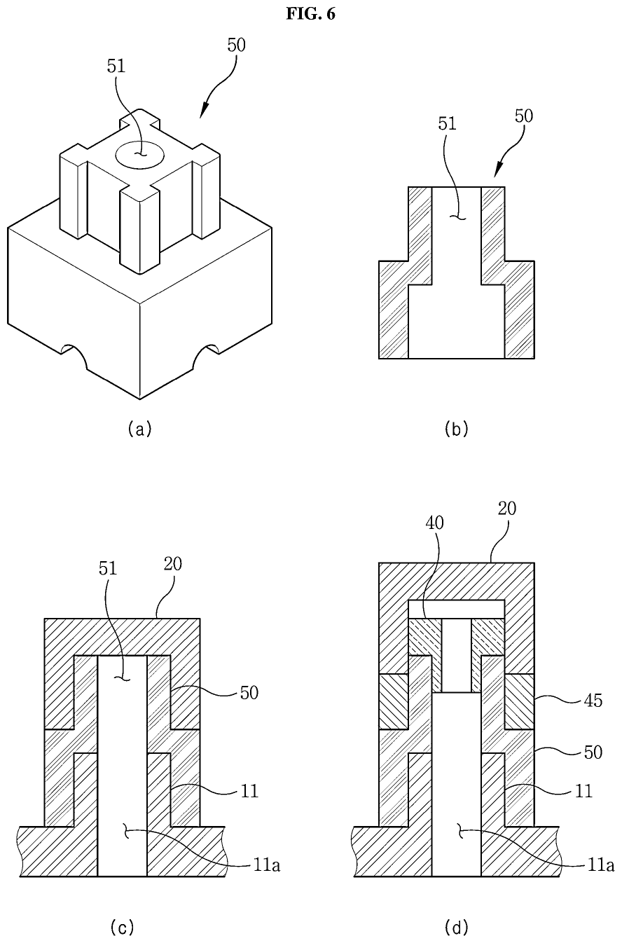

The block-type art kit 1 according to the present disclosure may further include a second adapter block 50. FIG. 6 shows various views illustrating a second adapter block 50 used in a block-type art kit according to the present disclosure (see (a), (b), (c), and (d) of FIG. 6).

The second adapter block 50 serves to connect the coupling protrusion 11 and the adapter block 40. That is, by sequentially coupling the second adapter block 50, the adapter block 40, and the color block 20 to the coupling protrusion 11 of the block frame 10, the color block 20 can be coupled to the block frame 10 through the second adapter block 50 and the adapter block 40.

The second adapter block 50 allows an image created by the block-type art kit 1 of the present disclosure to be formed more three-dimensionally.

Specifically, the second adapter block 50 is formed to surround the coupling protrusion 11 at a lower portion thereof and have at an upper portion thereof the same horizontal cross-section as that of the coupling protrusion 11. Both the adapter block 40 and the color block 20 can be coupled to the second adapter block 50. In addition, two or more second adapter blocks 50 can be coupled to each other, thereby allowing an image created by the block-type art kit 1 of the present disclosure to be more three-dimensional.

As shown in (d) of FIG. 6, the second adapter block 50 may be used together with the auxiliary adapter block 45. That is, by coupling the auxiliary adapter block 45 to the upper end of the second adapter block 50, it is possible to adjust the coupling length of the color block 20 to the second adapter block 50.

The second adapter block 50 has at the center thereof a second through hole 51 vertically penetrating the second adapter block 50. When a pin or the like passes through the through hole 11a of the block frame 10 and the second through hole 51 of the second adapter block 50, the color block 20 or the adapter block 40 can be easily separated from the second adapter block 50.

Like the block detachable hole 22 of the color block 20, a block detachable hole may be formed at the bottom of the side of the second adapter block 50.

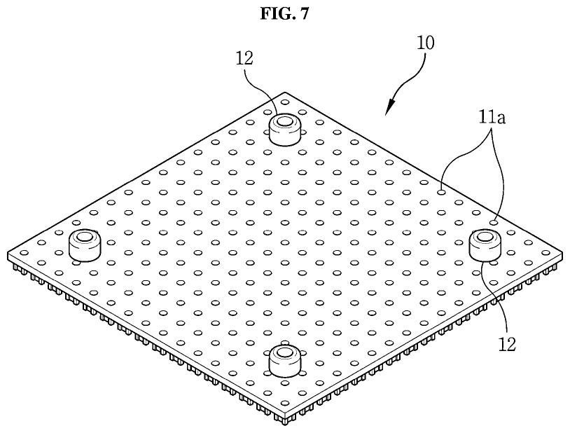

Meanwhile, a plurality of frame coupling protrusions 12 may be formed on the lower surface of the block frame 10. FIG. 7 is a perspective view illustrating a lower surface of a block frame 10 used in a block-type art kit according to the present disclosure.

The frame coupling protrusions 12 are arranged to be spaced apart in the row and column directions. The frame coupling protrusions 12 may be formed regardless of the location of the coupling protrusion 11. The frame coupling protrusions 12 may be used to connect different coupling frames.

Accordingly, it is possible to variously form the overall size or shape of an image created using the block-type art kit 1 of the present disclosure.

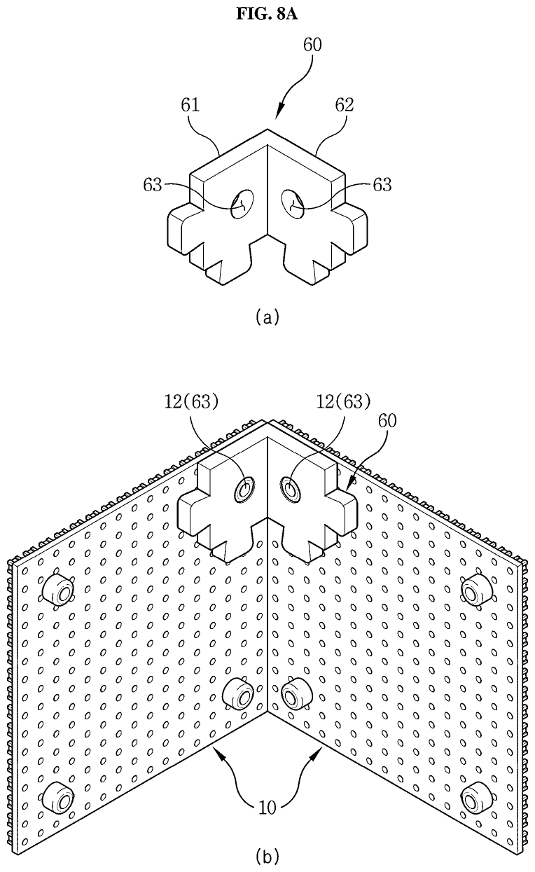

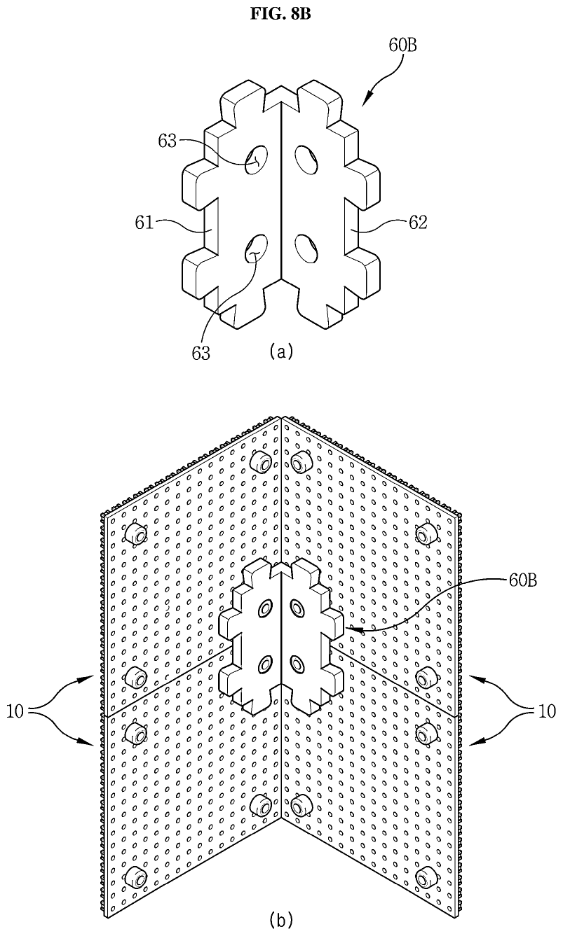

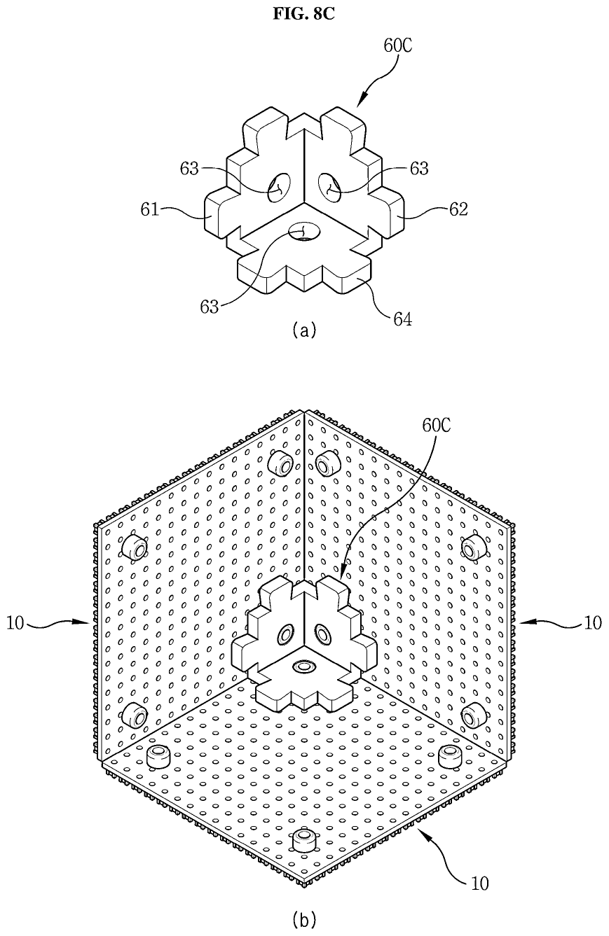

In the case where the block frame 10 includes the frame coupling protrusions 12, the block-type art kit 1 according to the present disclosure may further include a bent connection member 60. FIG. 8A illustrates a bent connection member 60 according to one embodiment of the present disclosure (see (a) and (b) of FIG. 8A).

The bent connection member 60 is composed of a first plate portion 61 and a second plate portion 62 connected to each other at a right angle. Each of the first plate portion 61 and the second plate portion 62 has a frame coupling hole 63 into which the frame coupling protrusion 12 can be inserted.

The bent connection member 60 can connect two block frames 10 at a right angle. That is, one block frame 10 is coupled to the frame coupling hole 63 of the first plate portion 61, and another block frame 10 is coupled to the frame coupling hole 63 of the second plate portion 62, so that the block frames 10 can be connected to each other at a right angle. Also, four block frames 10 can be combined with each other through four bent connection members 60 at right angles to form a box shape. For a firm coupling between adjacent block frames 10, two bent connection members 60 may be used to couple the adjacent block frames 10 at two positions.

FIG. 8B illustrates a bent connection member 60B according to another embodiment of the present disclosure (see (a) and (b) of FIG. 8B). The bent connection member 60B according to this embodiment not only connects the block frames 10 disposed side by side at a right angle, but also connects the block frames 10 disposed up and down. That is, only one bent connection member 60B can connect four block frames 10. To this end, in the bent connection member 60B according to this embodiment, two frame coupling holes 63 are formed in upper and lower parts of each of the first and second plate portions 61 and 62 connected to each other at a right angle. Two upper and lower block frames 10 can be coupled to the first plate portion 61 of the bent connection member 60B, and other two other upper and lower block frames 10 can be coupled to the second plate portion 62. This bent connection member 60B can be used to form a larger box shape.

FIG. 8C illustrates a bent connection member 60C according to yet another embodiment of the present disclosure (see (a) and (b) of FIG. 8C). The bent connection member 60C according to this embodiment can connect three block frames 10 disposed at right angles to each other. That is, it is possible to connect the block frames 10 disposed in the x, y, and z directions, respectively. To this end, the bent connection member 60C according to this embodiment includes a third plate portion 64 in addition to the first and second plate portions 61 and 62 connected to each other at a right angle. The third plate portion 64 is connected at a right angle to each of the first and second plate portions 61 and 62. The frame coupling hole 63 is formed in the third plate portion 64 as well. One block frame 10 can be coupled to each of the first, second, and third plate portions 61, 62, and 64 of the bent connection member 60C.

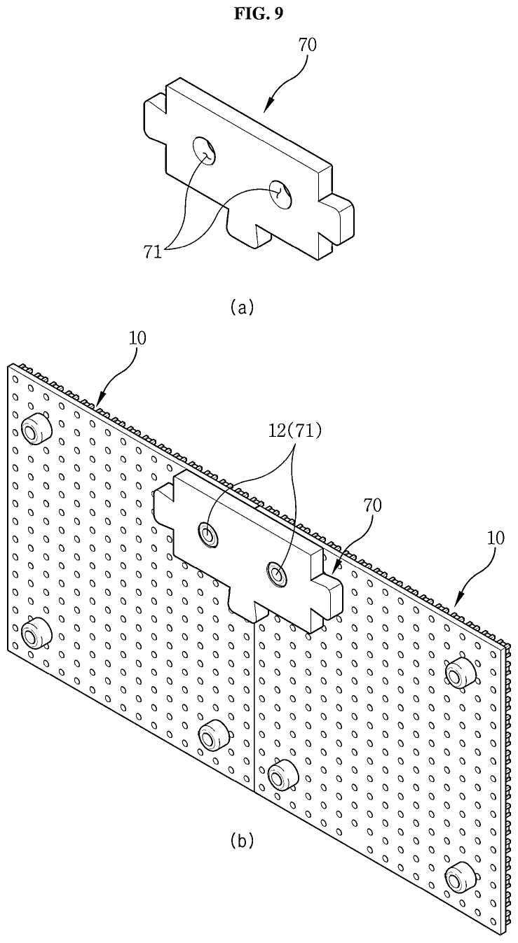

The block-type art kit 1 according to the present disclosure may further include a flat connection member 70. FIG. 9 illustrates a flat connection member 70 according to one embodiment of the present disclosure (see (a) and (b) of FIG. 9).

The flat connection member 70 has a long plate shape as a whole and has a plurality of second frame coupling holes 71 into which the frame coupling protrusions 12 can be inserted. For example, FIG. 9 shows a case where the flat connection member 70 has two second frame coupling holes 71.

The flat connection member 70 can connect two block frames 10 on the same plane. That is, one block frame 10 is coupled to one second frame coupling hole 71 of the flat connection member 70, and another block frame 10 is coupled to the other second frame coupling hole 71, so that the block frames 10 can be connected to each other on the same plane.

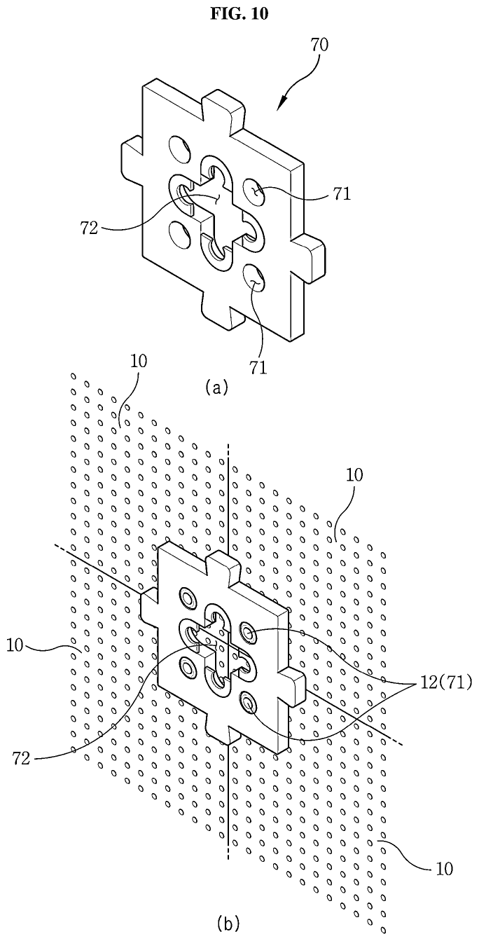

FIG. 10 illustrates a flat connection member 70 according to another embodiment of the present disclosure (see (a) and (b) of FIG. 10). As shown in FIG. 10, the flat connection member 70 has second frame coupling holes 71 at four portions and a frame fixing hole 72 at the center. This flat connection member 70 can connect four block frames 10 on the same plane by being coupled to the frame coupling protrusions 12 of different block frames 10 at four portions.

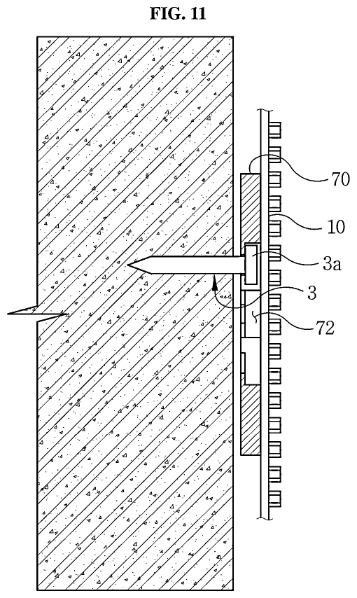

In the flat connection member 70 according to this embodiment, the frame fixing hole 72 is formed in a cross shape as a whole, and a fixing jaw is formed at each end of the cross shape. As shown in FIG. 11, a head 3a of a nail 3 can be engaged with the frame fixing hole 72, so that the block frame 10 can be fixed to a wall 4. That is, the head 3a of the nail 3 can be inserted into a central portion of the frame fixing hole 72 and then moved behind the fixing jaw, thereby being combined with the flat connection member 70.

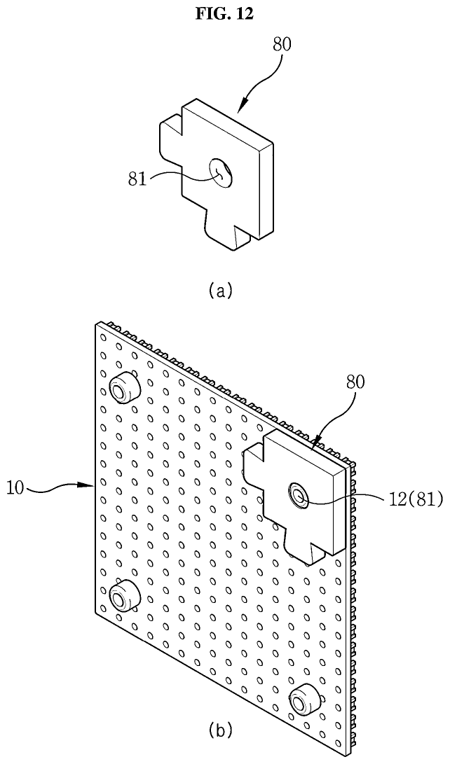

The block-type art kit 1 according to the present disclosure may further include a corner member 80. FIG. 12 illustrates a corner member 80 according to the present disclosure (see (a) and (b) of FIG. 12).

The corner member 80 has one third frame coupling hole 81 into which the frame coupling protrusion 12 of the block frame 10 can be inserted. The corner member 80 may have the same thickness as the flat connection member 70.

In the case where a plurality of block frames 10 are connected to each other by the flat connection members 70, the corner member 80 is fixed to each corner of an entire plate formed by the block frames 10. Therefore, the entire plate formed by the block frames 10 can have the same thickness along the circumference, and the entire plate can be stably fixed to the wall or the like.

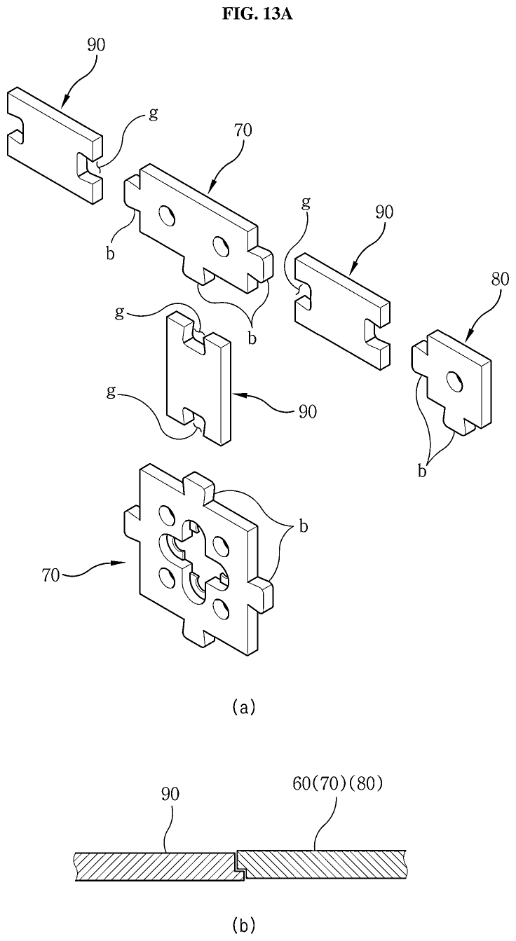

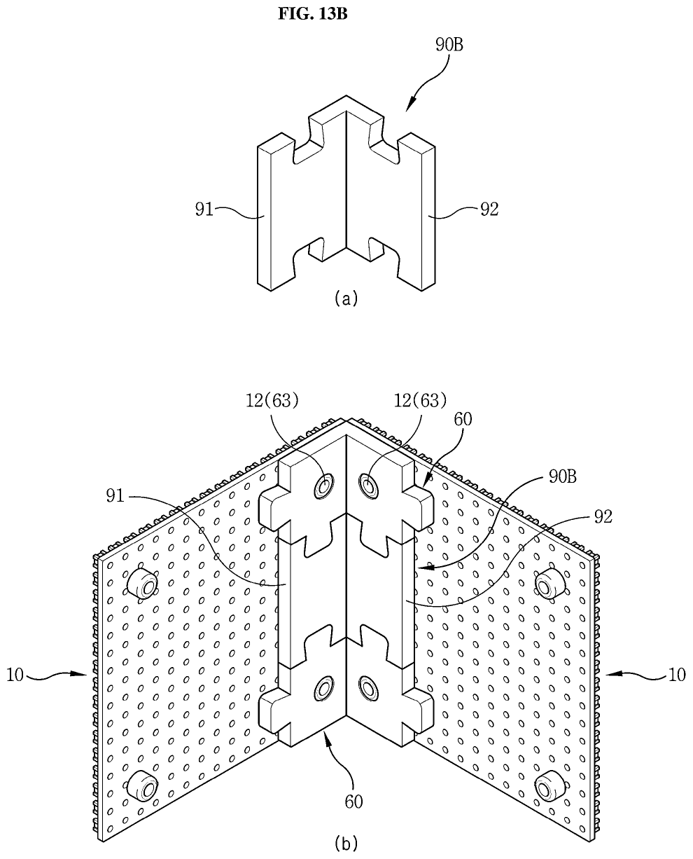

The block-type art kit 1 according to the present disclosure may further include an auxiliary connection member 90. FIG. 13A illustrates an auxiliary connection member 90 according to one embodiment of the present disclosure (see (a) and (b) of FIG. 13A).

In the case of connecting a plurality of block frames 10, the auxiliary connection member 90 is disposed between the flat connection members 70, between the bent connection member 60 and the flat connection member 70, or between the flat connection member 70 and the corner member 80, and is used to connect both members to each other. The auxiliary connection member 90 may have the same thickness as the flat connection member 70 and the like.

The auxiliary connection member 90 may have a female portion (g) (or a male portion (b)) formed at each of both ends thereof, and each member connected to the auxiliary connection member 90 may have a male portion (b) (or a female portion (g)) formed at each of some ends thereof. Therefore, the auxiliary connection member 90 and the members connected to the auxiliary connection member 90 may be firmly coupled to each other by the engagement of the female portion (g) and the male portion (b). As shown in (b) of FIG. 13A, the auxiliary connection member 90 and the members connected thereto may be formed to have corresponding steps to be engaged with each other in the thickness direction, thereby being more stably coupled without twisting each other in the thickness direction.

FIG. 13B illustrates an auxiliary connection member 90B according to another embodiment of the present disclosure (see (a) and (b) of FIG. 13B). The auxiliary connection member 90B according to this embodiment can be used in the case of connecting the block frames 10 at a right angle. The auxiliary connection member 90B according to this embodiment includes a first auxiliary plate 91 and a second auxiliary plate 92 connected to each other at a right angle. This auxiliary connection member 90B is combined at upper and lower portions thereof with the bent connection members 60, respectively.

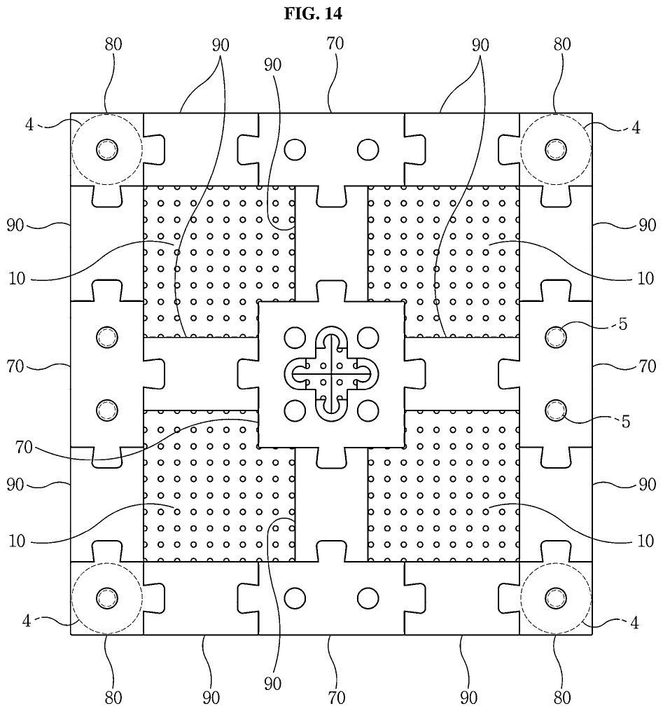

FIG. 14 is a view illustrating an exemplary connection of block frames 10 using flat connection members 70 and so on according to the present disclosure. For example, FIG. 14 shows a state in which four block frames 10 are connected to each other. The flat connection member 70 having two second frame coupling holes 71 is disposed at a portion where the two block frames 10 come into contact with each other. The flat connection member 70 having four second frame coupling holes 71 is disposed at a portion where the four block frames 10 come into contact with each other. The corner members 80 are disposed at corners of the entire plate formed by all the block frames 10. Each auxiliary connection member 90 is disposed between the flat connection members 70 or between the flat connection member 70 and the corner member 80. In the case of combining the block frames 10 three-dimensionally, the bent connection member 60 may be used instead of the corner member 80.

In addition, a suction plate 6 or a magnet 5 may be fixed to the second frame coupling hole 71 of the flat connection member 70 or the third frame coupling hole 81 of the corner member 80. Accordingly, the block-type art kit 1 according to the present disclosure can be fixed to a smooth surface such as a glass surface or a refrigerator surface.

While the present disclosure has been particularly shown and described with reference to exemplary embodiments thereof, it will be understood by those skilled in the art that various changes in form and details may be made therein without departing from the scope of the present disclosure as defined by the appended claims.

What is claimed is:

1. A block-type art kit comprising:
a block frame including a plurality of coupling protrusions arranged at regular intervals in row and column directions on an upper surface thereof; and
a plurality of color blocks each having a coupling recess provided on a lower surface thereof such that each of the coupling protrusions is inserted into a corresponding coupling recess,
wherein each coupling protrusion has a through hole formed at a center thereof in a direction penetrating the block frame.

2. The block-type art kit of claim 1, wherein the coupling protrusion has a rectangular shape on a horizontal cross-section and has an auxiliary coupling groove on each of four side surfaces.

3. The block-type art kit of claim 2, further comprising:
a plurality of quarter color blocks each formed to have a horizontal cross-section of a quarter of the size of the color block, each quarter color block having a second coupling recess at one lower corner portion thereof such that one corner portion of the coupling protrusion is inserted into the second coupling recess.

4. The block-type art kit of claim 1, wherein a block detachable hole is formed at a bottom of a side of the color block.

5. The block-type art kit of claim 1, further comprising:
an adapter block for connecting the coupling protrusion and the color block.

6. The block-type art kit of claim 5, wherein the adapter block has a horizontal cross-section of the same shape as that of the coupling protrusion and has a fixing protrusion formed on a lower surface thereof to be inserted into the through hole of the coupling protrusion.

7. The block-type art kit of claim 5, further comprising:
an auxiliary adapter block having a smaller height than the coupling protrusion, and having at a center thereof a coupling hole having a shape engaged with the coupling protrusion.

8. The block-type art kit of claim 5, further comprising:
a second adapter block for connecting the coupling protrusion and the adapter block.

9. The block-type art kit of claim 8, wherein the second adapter block is formed to surround the coupling protrusion at a lower portion thereof and have at an upper portion thereof the same horizontal cross-section as that of the coupling protrusion, and
wherein the second adapter block has at a center thereof a second through hole vertically penetrating the second adapter block.

10. The block-type art kit of claim 1, further comprising:
a plurality of frame coupling protrusions formed on a lower surface of the block frame and arranged to be spaced apart in the row and column directions.

11. The block-type art kit of claim 10, further comprising:
a bent connection member composed of a first plate portion and a second plate portion connected to each other at a right angle, each of the first plate portion and the second plate portion having a frame coupling hole into which the frame coupling protrusion is inserted.

12. The block-type art kit of claim 10, further comprising:
a flat connection member having a plate shape and having a plurality of second frame coupling holes into which the frame coupling protrusions are inserted.

13. The block-type art kit of claim 12, further comprising:
a corner member having one third frame coupling hole into which the frame coupling protrusion is inserted.
